(19) United States
(12) Patent Application Publication
(10) Pub. No.: US 2017/0292843 A1
(43) Pub. Date: Oct. 12, 2017

(54) AUTOMATED VEHICLE ROUTE PLANNER WITH ROUTE DIFFICULTY SCORING

(71) Applicant: DELPHI TECHNOLOGIES, INC., Troy, MI (US)

(72) Inventors: JUNQING WEI, PITTSBURGH, PA (US); JARROD M. SNIDER, PITTSBURGH, PA (US); JUNSUNG KIM, PITTSBURGH, PA (US); WENDA XU, PITTSBURGH, PA (US); GAURAV BHATIA, PITTSBURGH, PA (US); JONG HO LEE, PITTSBURGH, PA (US); VASUDEVA PAI MELGANGOLLI, PITTSBURGH, PA (US)

(21) Appl. No.: 15/093,021

(22) Filed: Apr. 7, 2016

(51) Int. Cl. G01C 21/34; G05D 1/00

(52) U.S. Cl. CPC G01C 21/34; G05D 1/0088

(57) ABSTRACT

A route-planning system suitable for use on an automated vehicle includes a memory and a controller. The memory is used to store map-data indicative of a plurality of possible-routes to a destination. Each possible-route is characterized by a difficulty-score. The controller is in communication with the memory. The controller is operable to select from the memory a preferred-route from the plurality of possible-routes. The preferred-route is selected based on the difficulty-score.

### TECHNICAL FIELD OF INVENTION

This disclosure generally relates to a route-planning system, and more particularly relates to a system that selects from a plurality of possible-routes a preferred-route based on a difficulty-score of each of the possible-routes.

### BACKGROUND OF INVENTION

Navigation systems that merely select a route based on shortest-distance or least-time are known. However these systems ignore many other factors that can influence the ease and/or safety of travel.

### SUMMARY OF THE INVENTION

In accordance with one embodiment, a route-planning system suitable for use on an automated vehicle is provided. The system includes a memory and a controller. The memory is used to store map-data indicative of a plurality of possible-routes to a destination. Each possible-route is characterized by a difficulty-score. The controller is in communication with the memory. The controller is operable to select from the memory a preferred-route from the plurality of possible-routes. The preferred-route is selected based on the difficulty-score.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a diagram of a route-planning system in accordance with one embodiment; and

FIG. 2 is map of routes selected by the system of FIG. 1 in accordance with one embodiment.

### DETAILED DESCRIPTION

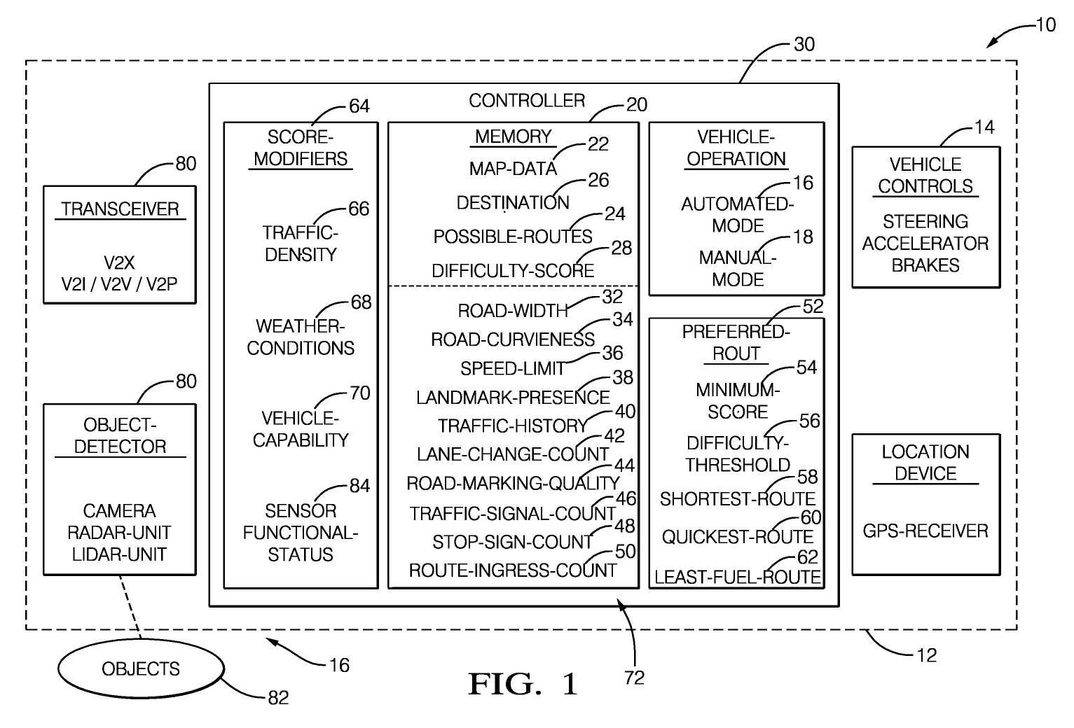

FIG. 1 illustrates a non-limiting example of a route-planning system 10, hereafter referred to as the system 10, which is suitable for use on an automated-vehicle 12, hereafter the vehicle 12. While the description and examples presented herein are generally directed to fully-automated or autonomous vehicles, it is contemplated that the advantages of the system 10 described herein are applicable to partially automated vehicles where assistance is provided to an operator (not shown) of the vehicle 12 who is generally in control of the vehicle-controls 14 of the vehicle 12. That is, the vehicle 12 may be operated in an automated-mode 16 (i.e. fully-automated) or a manual-mode 18, or a partial blend of those two modes.

The system 10 includes a memory 20 used to store map-data 22 indicative of a plurality of possible-routes 24 to a destination 26, wherein each possible-route is characterized by a difficulty-score 28. While the memory 20 is illustrated as being within a controller 30 of the system 10, it is contemplated that the memory 20 could be off-board, i.e. located ‘in-the-cloud’, and accessed by a number if known communications methods such as a WI-FI® network or cellular telephone network.

The difficulty-score 28 of each of the possible-routes 24 may be calculated or accumulated from predetermined values for each section of roadway present in the map-data 22 that were defined by a mapping-service. The difficulty-score 28 of a particular route may be an accumulation of these predetermined values or sections or roadway used to form the route. The difficulty-score 28 may be based on one or more roadway-characteristics 72 such as, but not limited to, road-width 32, road-curviness 34, speed-limit 36, landmark-presence 38, traffic-history 40, lane-change-count 42, roadway-marking-quality 44, traffic-signal-count 46, stop-sign-count 48, and route-ingress-count 50. That is, the difficulty-score 28 of each of the possible-routes 24 may be a summation of the predetermined values for each of the sections of roadway that will be traveled if the vehicle 12 travels a particular route.

The accumulation or summation process may have different weightings applied to the roadway-characteristics 72 for different vehicles. For example, a large-truck may use a greater weighting than a sports-car for the road-width 32 or the road-curviness 34. Alternatively, a single instance of one of the roadway-characteristics 72 being greater than some threshold value may be sufficient for the vehicle 12 to not select one of the possible-routes 24 as the preferred-route 52.

The predetermined values may be updated as, for example, the roadway-marking-quality 44 deteriorates due to age, or the road-width 32 changes as the result of a construction project. The updates may be based on, for example, images sent from cameras on vehicles that previously traveled a particular section of roadway, and on other more dynamic conditions such as weather which will be described in more detail below.

The controller 30 is in communication with the memory 20. The controller 30 is operable (i.e. programmed) to select from the memory 20 a preferred-route 52 from the plurality of possible-routes 24. The preferred-route 52 is generally selected based on the difficulty-score 28 of each of the possible-routes 24. By way of example and not limitation, the difficulty-score 28 of the preferred-route 52 may be characterized as the possible-route that has the minimum difficulty-score or a minimum-score 54 of the possible-routes 24. However, it is recognized that simply selecting the preferred-route 52 based on which of the possible-routes has the minimum-score 54 may lead to, for example, unnecessarily long travel-times to the destination 26.

Alternatively, the difficulty-score 28 of the preferred-route 52 may be selected based on the criteria that the difficulty-score 28 is at least less than a difficulty-threshold 56, which may be predetermined by the mapping service, determined by the type of the vehicle 12 (e.g. large-truck vs. sports-car), or selected by an operator of the vehicle 12. That is, the preferred-route 52 may not necessary be the absolutely easiest route to drive, for example, but it is sufficiently easy. In addition to having a sufficiently low value of the difficulty-score 28, the preferred-route 52 may be further selected based on which of the possible-routes 24 has or is characterized as a shortest-route 58 based on a comparison of indicated travel distances, a quickest-route 60 based on a comparison of projected travel times, and/or a least-fuel-route 62 based on an estimate of how much fuel will be consumed by traveling each of the possible-routes 24.

While having a predetermined value of the difficulty-score 28 for each of the possible-routes 24 may be advantageous for reasons of convenience and/or consistency, it is contemplated that those baseline values of the difficulty-score 28 may be advantageously modified using score-modifiers 64 to take into account a variety of special situations or conditions. For example, the difficulty-score 28 of each of the possible-routes 24 may be modified based on one or more of traffic-density 66 as reported by a traffic information service, weather-conditions 68 as reported by a weather report service, and vehicle-capability 70 as indicated by the general design of the vehicle 12. For example, the baseline values of the difficulty-score 28 may be used if the weather report indicates that the roads are dry. However, if one or more of the sections of roadways that form a particular route are snow-covered, the difficulty-score 28 for that particular route may be increased, possibly to a value greater than the difficulty-threshold 56. For example, a twisty mountain pass may have an acceptable value of the difficulty-score 28 less than the difficulty-threshold 56 when dry, but greater than the difficulty-threshold 56 when snow covered. As another example, a short up-hill merge ramp from a stop-sign onto an express-way may be acceptable for a typical automobile, but too difficult for a heavy truck, so the heavy truck may look for an alternative route.

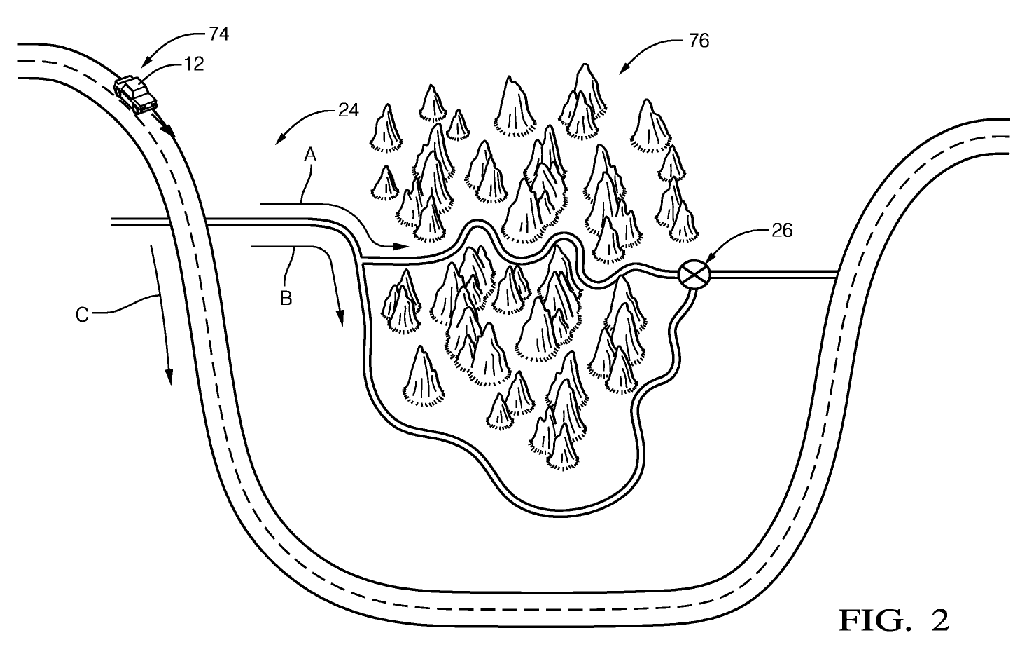

FIG. 2 illustrates a non-limiting example of a plurality of possible-routes 24 from a present-location 74 to a destination 26. Route A uses a secondary, typically a two-lane road, through a mountain-range 76 that is relatively narrow, twisty, and includes substantive elevation changes. Route B also uses a secondary type road, but is less twisty with fewer elevation changes when compared to route A. Route C uses a divided highway or express-way for most of the trip to the destination 26. If the roads are dry and the vehicle 12 is capable (e.g. a typical automobile), then route A may be selected as the preferred-route 52 because it quicker, i.e. has the least travel-time. If route A is snow-covered, then route B may be selected as the preferred-route for an automobile because route B is still quicker and more fuel efficient that route C. However, if the vehicle 12 is a large truck, route C may be the preferred-route 52 because a slow-moving truck may impede the travel of other vehicles if the large truck uses route A or route B.

Referring back to FIG. 1, the system 10 may include a plurality of sensors 80 used to detect or determine the presence of an object 82 or gather information about the roadway being traveled. The plurality of sensors 80 may include, but is not limited to, a camera, a radar-unit, a lidar-unit, or any combination thereof that may be useful to detect, determine a location of, and/or identify the object 82. The plurality of sensors 80 may also include a transceiver used for vehicle-to-infrastructure (V2I) communications, vehicle-to-vehicle (V2V) communications, or vehicle-to-pedestrian (V2P) communications, which are sometimes generically labeled V2X communications. The difficulty-score 28 of each of the possible-routes 24 may be modified based on functional-status 84 of each sensor. For example, the preferred-route 52 may be selected to avoid high-speed roads if the long-range detection capability of the radar-unit is not functional. As another example, the preferred-route 52 may be selected to avoid routes with numerous traffic-lights if transceiver that provides for V2I communication has failed.

It is also contemplated that the vehicle-capability 70 may change over time, i.e. the software that operates the vehicle 12 may ‘learn’ the vehicle-capability 70. For example, when a car's first delivered, the driving algorithm installed in the vehicle 12 may not be mature enough for it to handle some sharp turns. So the system 10 will avoid those turns. Eventually, through self-learning, the algorithm is upgraded or tuned so the vehicle 12 can handle those sharp turns. That is, the navigation system may modify the computing of the difficulty-score 28 so that the vehicle 12 can select a route with sharp turns in it that it would have initially avoided.

Accordingly, a route-planning system (the system 10), a controller 30 for the system 10 and a method of operating the system 10 is provided. The system is an improvement over prior navigation systems that merely select a route based on shortest-distance or least-time because the system 10 takes into consideration the roadway-characteristics 72 of the possible-routes 24 which are relatively fixed, and takes into consideration dynamic conditions (the score-modifiers 64) such as weather.

While this invention has been described in terms of the preferred embodiments thereof, it is not intended to be so limited, but rather only to the extent set forth in the claims that follow.

We claim:

1. A route-planning system suitable for use on an automated vehicle, said system comprising:
a memory used to store map-data indicative of a plurality of possible-routes to a destination, wherein each possible-route is characterized by a difficulty-score;
a controller in communication with the memory, said controller operable to select from the memory a preferred-route from the plurality of possible-routes, wherein the preferred-route is selected based on the difficulty-score.

2. The system in accordance with claim 1, wherein the difficulty-score of the preferred-route is characterized as a minimum of difficulty-scores of possible-routes.

3. The system in accordance with claim 1, wherein the difficulty-score of the preferred-route is less than a difficulty-threshold and the preferred-route is one of a shortest-route, a quickest-route, and a least-fuel-route of the plurality of possible-routes.

4. The system in accordance with claim 1, wherein the difficulty-score of each possible-route is determined based on one or more of road-width, road-curviness, speed-limit, landmark-presence, traffic-history, lane-change-count, roadway-marking-quality, traffic-signal-count, stop-sign-count, and route-ingress-count.

5. The system in accordance with claim 1, wherein the difficulty-score of each possible-route is modified based on one or more of traffic-density, weather-conditions, and vehicle-capability.

6. The system in accordance with claim 1, wherein the system includes a plurality of sensors, and the difficulty-score of each possible-route is modified based on functional-status of each sensor.
